(19) United States
(12) Patent Application Publication
(10) Pub. No.: US 2026/0233422 A1
(43) Pub. Date: Aug. 13, 2026

(54) SHAVING CARTRIDGE

(71) Applicant: The Gillette Company LLC, Boston, MA (US)

(72) Inventors: Jahdiel Fyfield, Roslindale, MA (US); Christopher Ramm, North Attleboro, MA (US); Lindsey McLane Sharlow, Boston, MA (US); Anthony Stephen Wilkinson, Somerville, MA (US)

(21) Appl. No.: 19/049,189

(22) Filed: Feb. 10, 2025

(51) Int. Cl. B26B 21/40; B26B 21/22; B26B 21/44

(52) U.S. Cl. CPC B26B 21/4031; B26B 21/4018; B26B 21/4025; B26B 21/443; B26B 21/225

(57) ABSTRACT

In one aspect, the invention features, in general, a shaving cartridge with a housing having a guard and a cap. At least one blade is mounted to the housing. The at least one blade has a cutting edge positioned between the guard and the cap. A leading skin bar extends forward of the guard. The leading skin bar includes an upper skin facing surface with an arcuate forward edge closest to the cutting edge toward a center axis of the leading skin bar and further away from the cutting edge toward a pair of opposing lateral ends of the housing. A length of the arcuate forward edge measured parallel to the at least one blade is greater than or equal to 60% of a length extending between the pair of opposing lateral ends.

### FIELD OF THE INVENTION

The present invention relates to shaving razors and more particularly to wet shaving razor cartridges having a leading skin bar for skin management during a shaving stroke.

### BACKGROUND OF THE INVENTION

In general, shaving razors of the wet shave type include a cartridge or blade unit with at least one blade with a cutting edge, which is moved across the surface of the skin being shaved by means of a handle to which the cartridge is attached. The cartridge may be mounted detachably on the handle to enable the cartridge to be replaced by a fresh cartridge when the blade sharpness has diminished to an unsatisfactory level, or it may be attached permanently to the handle with the intention that the entire razor be discarded when the blade or blades have become dulled (i.e., disposable razor). The connection of the cartridge to the handle provides a pivotal mounting of the cartridge with respect to the handle so that the cartridge angle adjusts to follow the contours of the surface being shaved. In such systems, the cartridge can be biased toward a rest position by the action of a spring-biased plunger (a cam follower) carried on the handle against a cam surface on the cartridge housing.

Razor cartridges usually include a guard which contacts the skin in front of the blade(s) and a cap for contacting the skin behind the blade(s) during shaving. The cap and the guard aid in establishing the so-called “shaving geometry”, i.e., the parameters which determine the blade orientation and position relative to the skin during shaving, which in turn have a strong influence on the shaving performance and efficacy of the razor. The cap and the guard may aid in establishing the exposure of the blades. The blade exposure is defined to be the perpendicular distance or height of the blade edge measured with respect to a plane tangential to the skin contacting surfaces of the blade unit elements next in front of and next behind the edge. Therefore, for a three-bladed blade unit, the exposure of the first or primary blade is measured with reference to a plane tangential to the guard and the edge of the second blade, and the exposure of the third or tertiary blade is measured with reference to a plane tangential to the edge of the second blade and the cap.

The minimum acceptable exposure may be influenced by other blade unit dimensions, such as the distance from the skin engaging surface of the guard to the edge, i.e. “the span” of the primary blade. As referred to herein, “the span” means the distance from the blade edge to the skin contacting element immediately in front of that edge as measured along a tangent line extending between the said element and the blade edge. The guard may include a generally rigid guard bar that may be formed integrally with the housing or platform structure, which provides a support for the blades. Guards may also include skin stretching elements made from various types of elastomeric materials that are intended to stretch the skin and/or align hair in front of the blade.

Safety razors having cartridges with several blades have in recent years been sold in very large numbers and are generally acknowledged to give a better quality of shave, especially in terms of closeness, than single bladed razors. The addition of more blades or elements attached to the blades may increase shaving comfort by reducing blade load. The term “blade load” as used herein signifies the force applied by an individual blade onto a substrate such as the skin. The addition of blades and inter-blade skin support elements not only increase the overall footprint of the shaving razor cartridge, but also the cost. Thus, there is still a need to improve skin management without adding cost or increasing the size of the shaving surface. Accordingly, what is needed is a shaving razor cartridge that provides a more comfortable shave and/or decrease skin issues caused by shaving the face and body.

### SUMMARY OF THE INVENTION

In one aspect, the invention features, in general, a shaving cartridge with a housing having a guard and a cap. The cap and the guard define a shave plane. At least one blade is mounted to the housing. The at least one blade has a cutting edge positioned between the guard and the cap. A leading skin bar extends forward of the guard. The leading skin bar includes an upper skin facing surface with an arcuate forward edge closest to the cutting edge toward a center axis of the leading skin bar and further away from the cutting edge toward a pair of opposing lateral ends of the housing. A length of the arcuate forward edge measured parallel to the at least one blade is greater than or equal to 60% of a length extending between the pair of opposing lateral ends.

In another aspect, the invention features, in general, a shaving cartridge with a housing having a guard and a cap. The cap and the guard define a shave plane. At least one blade is mounted to the housing. The at least one blade has a cutting edge positioned between the guard and the cap. A pair of clips are mounted to the housing securing the at least one blade to the housing. A leading skin bar extends forward of the guard. The leading skin bar includes an upper skin facing surface with an arcuate forward edge closest to the cutting edge toward a center axis of the housing and further away from the cutting edge toward a pair of opposing lateral ends of the housing. A length of the arcuate forward edge measured parallel to the at least one blade is greater than or equal to 60% of a distance extending between the pair of clips.

In yet another aspect, the invention features, in general, a shaving cartridge with a housing having a guard and a cap. A plurality of blades are positioned between the guard and the cap. Each of the blades has a cutting edge. The cutting edges defining a shave plane. A leading skin bar extends in front of the guard. The leading skin bar has a concave skin facing surface when viewed in cross section along a center axis of the leading skin bar that is transverse to the shave plane.

In yet another aspect, the invention features, in general, a shaving cartridge with a housing having a guard and a cap. A plurality of blades are positioned between the guard and the cap. Each of the blades has a cutting edge. The cutting edges define a shave plane. A leading skin bar extends in front of the guard. The leading skin bar has a concave skin facing surface when viewed in cross section along a center axis of the leading skin bar that is transverse to the shave plane. The concave skin facing surface has a radius of about 5 mm to about 35 mm.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 is a perspective view of a shaving cartridge.

FIG. 2 is a top view of the shaving cartridge of FIG. 1

FIG. 3 is a section view of the shaving cartridge, taken generally along the line 3-3 of FIG. 2.

FIG. 4 is a section view of the shaving cartridge, taken generally along the line 4-4 of FIG. 2.

FIG. 5 is a section view of the shaving cartridge, taken generally along the line 5-5 of FIG. 2.

### DETAILED DESCRIPTION OF THE INVENTION

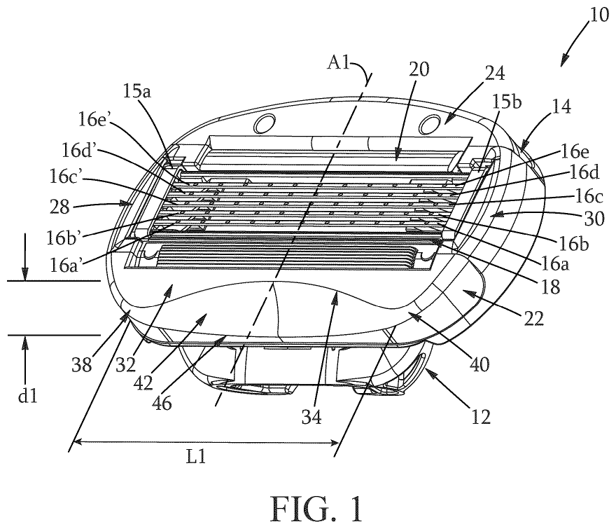

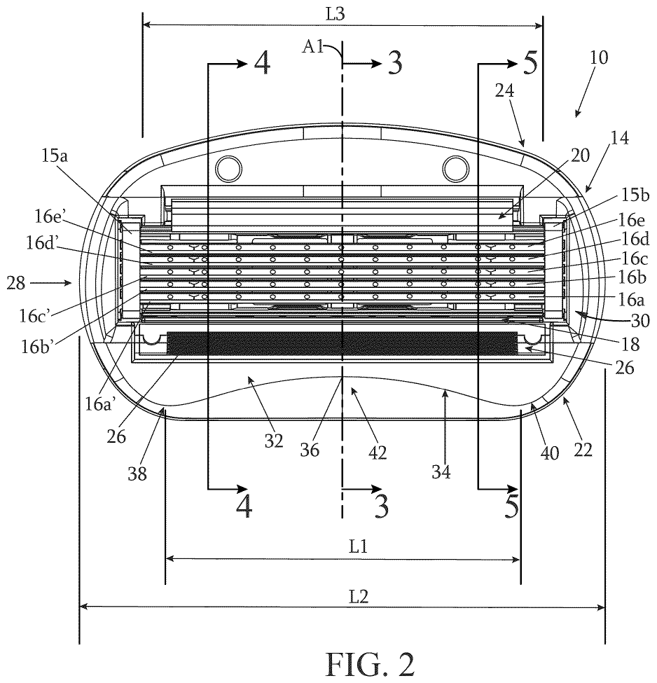

Referring to FIGS. 1 and 2, one possible embodiment of the present disclosure is shown illustrating perspective view and a top view of a shaving cartridge 10, respectively. In certain embodiments, the shaving cartridge 10 may be detached and removed from a handle (not shown). The shaving cartridge 10 may be fixedly or pivotably mounted to the handle depending on the overall desired cost and performance. The shaving cartridge 10 may also include an interconnect member 12 (FIG. 1) to which a housing 14 of the shaving cartridge 10 is pivotably mounted about a pivot axis.

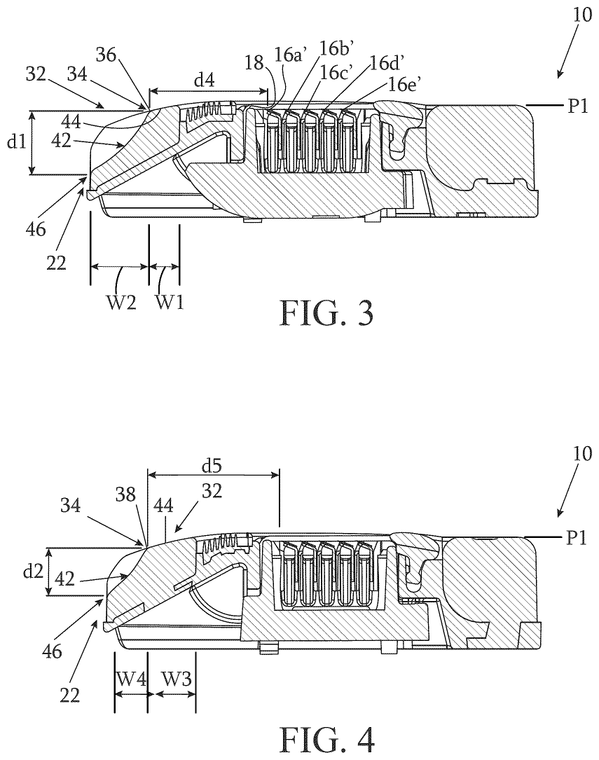

The housing 14 may carry one or more blades 16 (e.g., a first blade 16a, second blade 16b, a third blade 16c, a fourth blade 16d and a fifth blade 16d), a guard 18 and a cap 20. The first blade 16a may be mounted to the housing 14 closest to the guard 18. In certain embodiments, the blades 16 may all face in the same direction (e.g., towards the guard 18). However, it is understood that some of the blades 16 may face the guard 18 and some of the blades may face the cap 20 for bi-directional shaving. The fifth blade 16e (e.g., the last blade) may be mounted to the housing closest to the cap 20. Although five blades 16 are illustrated, it is understood that more or less blades 16 may be mounted to the housing 16 depending on the desired cost and performance of the shaving cartridge 10. Each of the first blade 16a the second blade 16b, the third blade 16c, the fourth blade 16d and the fifth blade 16d may have a respective cutting edge (e.g., a first cutting edge 16a′, first cutting 16b′, a third first cutting 16c′, a fourth first cutting 16d′ and a fifth first cutting 16d′). The first cutting edge 16a′, the first cutting 16b′, the third first cutting 16c′, the fourth first cutting 16d′ and the fifth first cutting 16d′ may define a shave plane P1 (FIG. 3). The blades 16a, 16b, 16c, 16d and 16e may be rigidly fixed to the housing 14 such that the blades 16a, 16b, 16c, 16d and 16e do not move relative to the housing 14 during a shaving stroke. Alternatively, the blades 16a, 16b, 16c, 16d and 16e may be spring mounted within the housing 14.

The one or more blades 16a, 16b, 16c, 16d and 16e may be mounted within the housing 14 and secured with one or more clips 15a and 15b. The clips 15a and 15b may be parallel to each other and may extend into the housing 14 to secure the blades 16a, 16b, 16c, 16d and 16e to the housing 14. Other assembly methods known to those skilled in the art may also be used to secure the one or more blades 16a, 16b, 16c, 16d and 16e to the housing 14 including, but not limited to wire wrapping, cold forming, hot staking, insert molding, and adhesives.

The cap 20 may comprise a water soluble shaving aid that is injection molded, extruded, or thermal/ultrasonic compression. The cap 20 may be part of the housing 12 or mounted to the housing 12 (e.g., via press fit or snap fit to the housing 12). Alternatively, the cap 20 may be integral with the housing 12 and treated or coated to reduce friction and improve glide of the shaving cartridge 10 against the skin during a shaving stroke. For example, the cap 20 may be coated with poly-para-Xylylene or PTFE or plated (e.g., chrome plating) to improve lubricity. The cap 20 (and the housing 12) may be machined or formed from aluminum that is anodized to improve lubricity and provide color options.

A leading skin bar 22 may be positioned in front of the guard 18 and a trailing skin bar 24 may be positioned behind the cap 20. In certain embodiments, the leading skin bar 22 and/or the trailing skin bar 24 may comprise the shaving aid composition (e.g., a water leachable shaving aid composition). The one or more blades 16 may be positioned between the guard 18 and the cap 20. In certain embodiments, an elastomeric member 26 may be mounted to the housing 14 between the guard 18 and the leading skin bar 22 (i.e., in front of the guard 18 and behind the leading skin bar 22). The elastomeric member 26 include a plurality of protrusions, such as fins, to improve skin stretching during a shaving stroke. The guard 18 may be a continuous bar, as shown, or segmented to facilitate alignment of hair during a shaving stroke. The housing 18 may be molded from semi-rigid polymers having a Shore A hardness of about 50, 60, or 70 to about 90, 110, or 120.

The leading skin bar 22 and/or the trailing skin bar 24 may be molded to the housing 14 using insert injection molding (two-shot molding) or insert injection molding. The leading skin bar 22 and/or the trailing skin 24 bar may be molded from a material to provide sufficient stiffness such that leading skin bar 22 and/or the trailing skin 24 bar do not bend or flex under normal shaving conditions, which may adversely influence shave geometry. The leading skin bar 22 and/or the trailing skin bar 24 may be molded from the shaving aid composition having one or more water-leachable shaving aid materials to provide increased comfort during shaving (e.g., lubrication, moisturization and/or other skin benefits). One or more layers of the shaving aid composition may be molded to the housing 14 to form the leading skin bar 22 and/or the trailing skin bar 24. The shaving aid composition comprise one or more polymeric materials. For example, the shaving aid composition may include a water-insoluble polymer material comprising ethylene vinyl acetate (EVA) and combined with a water-soluble polymer material and other optional adjunct or secondary ingredients to provide one or more skin benefits, such as increased lubrication and improve skin moisturization.

The following examples disclose shaving aid compositions which may be incorporated into the leading skin bar 22 and/or the trailing skin bar 24. In use, they were observed to provide adequate lubrication and a comfortable shave.

EXAMPLE 1

| Material | Example 1 |
|---|---|
| Elvax 750 | 27% |
| PEO 308 | 0% |
| Irganox 245 | 1.5% |
| PEG 4600 | 5% |
| CEVA 939FF Light Teal | 4% |
| PCL CAPA 6506 | 5% |
| PEO N60K | 8.6% |
| PEO Coagulant | 48.9% |

Additional water-insoluble polymers can also be used, in addition to the EVA. Examples of additional water-insoluble polymers include those known in the art and used in skin engaging members found on razors today. Specific water-insoluble polymers which can be used include polyethylene (PE), polypropylene, polystyrene (PS), butadiene-styrene copolymer (e.g. medium and high impact polystyrene), polyacetal, acrylonitrile-butadiene-styrene copolymer, ethylene vinyl acetate copolymer, polyurethane, and blends thereof, such as polypropylene/polystyrene blend or polystyrene/impact polystyrene blend. These matrix polymers can also be free or essentially free of one of more of these additional water-insoluble polymers. Suitable water soluble polymers which can be used in accordance with the present invention include, but are not limited to, one or more of: a polyethylene oxide, polyvinyl pyrrolidone, polyacrylamide, polyhydroxymethacrylate, polyvinyl imidazoline, polyethylene glycol, polyvinyl alcohol, polyhydroxyethymethacrylate, silicone polymers, and mixtures thereof. In one embodiment, said water soluble polymer is selected from the group consisting of polyethylene oxide, polyethylene glycol, and a mixture thereof.

In certain embodiments, the shaving aid composition 12 may comprise other ingredients commonly found in commercially available skin engaging members. Non-limiting examples of such skin engaging members include those disclosed in U.S. Pat. Nos. 6,301,785, 6,442,839, 6,298,558, 6,302,785, and U.S Patent Pubs 2008/060201, and 2009/0223057. In one embodiment, the skin engaging member further comprises a skin engaging member ingredient selected from the group consisting of polyethylene oxide, polyvinyl pyrrolidone, polyacrylamide, hydroxypropyl cellulose, polyvinyl imidazoline, polyethylene glycol, poly vinyl alcohol, polyhydroxyethylmethacrylate, silicone copolymers, sucrose stearate, vitamin E, soaps, surfactants, panthenol, aloe, plasticizers, such as polyethylene glycol; beard softeners; additional lubricants, such as silicone oil, TEFLON® polytetrafluoroethylene powders (manufactured by DuPont), and waxes; essential oils such as menthol, camphor, eugenol, eucalyptol, safrol and methyl salicylate; tackifiers such as Hercules Regalrez 1094 and 1126; non-volatile cooling agents, inclusion complexes of agents skin-soothing with cyclodextrins; fragrances; antipruritic/counterirritant materials; antimicrobial/keratolytic materials such as Resorcinol; anti-inflammatory agents such as Candilla wax and glycyrrhetinic acid; astringents such as zinc sulfate; surfactants such as pluronic and iconol materials; compatibilizers such as styrene-b-EO copolymers; mineral oil, polycaprolactone (PCL), and combinations thereof.

The shaving aid composition may include one or more skin lubricating water-soluble polymers such as, polyethylene oxide, polyvinyl pyrrolidone, polyacrylamide, hydroxypropyl cellulose, polyvinyl imidazoline, and polyhydroxyethylmethacrylate. Other water-soluble polymers may include the polyethylene oxides generally known as POLYOX (available from Dow Chemical) or ALKOX (available from Meisei Chemical Works, Kyota, Japan). These polyethylene oxides may have molecular weights of about 100,000 to 6 million, for example, about 300,000 to 5 million. The polyethylene oxide may comprises a blend of about 40 to 80% of polyethylene oxide having an average molecular weight of about 5 million (e.g., POLYOX COAGULANT) and about 60 to 20% of polyethylene oxide having an average molecular weight of about 300,000 (e.g., POLYOX WSR-N-750). The polyethylene oxide blend may also contain up to about 10% by weight of a low molecular weight (i.e., MW<10,000) polyethylene glycol such as PEG-100.

The shaving aid composite may also optionally include an inclusion complex of a skin-soothing agent with a cylcodextrin, low molecular weight water-soluble release enhancing agents such as polyethylene glycol (e.g., 1-10% by weight), water-swellable release enhancing agents such as cross-linked polyacrylics (e.g., 2-7% by weight), colorants, antioxidants, preservatives, microbicidal agents, beard softeners, astringents, depilatories, medicinal agents, conditioning agents, moisturizers, cooling agents, etc.

The molding of the leading skin bar 22 and/or the trailing skin bar 24 may allow for a greater variety of shapes (e.g., compared to extruded lubrication bars that are later assembled to a shaving cartridge housing) and different surface textures to be added. In certain embodiments, the leading skin bar 22 and the trailing skin bar 24 may be spaced apart by a portion of the housing 14 (e.g., lateral ends 28 and 30 of the housing 14), when viewed from a top of the shaving cartridge 10. The leading skin bar 22 may have an upper skin facing surface 32 and an opposing bottom surface (not shown). The upper skin facing surface 32 may include an arcuate forward edge 34 having a midpoint 36 (FIG. 2) positioned along a center axis A1 of the leading skin bar 32, that is transverse to the shave plane P1 (FIG. 3). The arcuate forward edge 34 may be closest to the cutting edge 16a′ of the first blade 16a (i.e., the blade 16a closest to the guard 18) at the midpoint 36. The distance from the cutting edge 16a′ of the first blade 16a to the arcuate forward edge 34 may increase as the arcuate forward edge 34 extends in a lateral direction away from the midpoint 36.

The arcuate forward edge 34 may extend laterally outward from the midpoint 36 and down and away from the first blade 16a toward a pair of lateral ends of the arcuate forward edge 34. For example, the arcuate forward edge 34 may be furthest from the cutting edge 16a′ of the first blade 16a toward a pair of lateral ends 38 and 40 of the arcuate forward edge 34. In certain embodiments, the lateral ends 38 and 40 of the arcuate forward edge 34 may be about 0.50 mm to about 1.50 mm and more preferably about 0.75 mm to about 1.0 mm from the shave plane P1. The pair of lateral ends 38 and 40 may be located where the arcuate forward edge 34 begins to extend back toward the first blade 16a. The arcuate forward edge 34 may extend a length “L1” (measured parallel to the first blade edge 16a′) of about 20 mm to about 40 mm and preferably about 25 mm to 35 mm between the pair of lateral ends 38 and 40. The length L1 of the arcuate forward edge 34 may be greater than or equal to 60% of a length L2 extending between the pair of opposing lateral ends 28 and 30 of the housing 14. For example, length L1 of the arcuate forward edge 34 may be 60% to 90% and preferably 65% to 85% of the length L2 extending between the pair of opposing lateral ends 28 and 30 of the housing 14. In certain embodiments, L2 may be about 35 mm to about 55 mm and preferably about 40 mm to about 45 mm. The length L1 of the arcuate forward edge 34 may also be a certain percentage of a cutting length of the one or more cutting edges 16a′, 16b′, 16c′, 16d′ and 16e′, for example, a length L3 between a pair of clips 15a and 15b that secure the blades 16a, 16b, 16c, 16d and 16e to the housing 14. The length L1 of the arcuate forward edge 34 measured parallel to the blades 16 may be greater than or equal to 60% of the length L3 extending between the pair of clips 15a and 15b. For example, length L1 of the arcuate forward edge 34 may be 60% to 100% and preferably 70% to 90% of the length L3. In certain embodiments, the length L3 may be about 30 mm to about 40 mm. In certain embodiments, the arcuate forward edge 34 may have a radius of about 20 mm to about 50 mm and preferably about 35 mm to about 40 mm.

Referring to FIG. 3, a cross sectional view, taken generally along the line 3-3 of FIG. 2 is illustrated. The upper skin facing surface 32 of the leading skin bar 22 may have a concave skin facing surface 42 (see also FIG. 1) when viewed in cross section along the center axis A1 of the leading skin bar 22. In certain embodiments, the concave skin facing surface 42 may have a radius of about 5 mm to about 35 mm and more preferably about 7 mm to about 20 mm. Accordingly, the arcuate forward edge 34 may be closer to the shave plane P1 toward or at the midpoint 36 than at or toward the lateral ends 38 and 40 of the arcuate forward edge 34. For example, the arcuate forward edge 34 may be positioned on or above the shave plane P1 at the midpoint 36 and the arcuate forward edge 34 may be positioned below the shave plane P1 at the lateral ends 38 and 40. The arcuate forward edge 34 may extend more toward the shave plane P1 closer to the midpoint 36. In certain embodiments, the midpoint 36 of the arcuate forward edge 34 may be closest to the shave plane P1 (e.g., at the shave plane P1, slightly above and/or slightly below). For example, the midpoint 36 may be about 0.5 mm above the blade plane P1 to about 0.5 mm below the blade plane P1 and preferably about 0.25 mm above the blade plane P1 to about 0.25 mm below the blade plane P1. In certain embodiments, the concave skin facing surface 42 may have a length that is the same as L1.

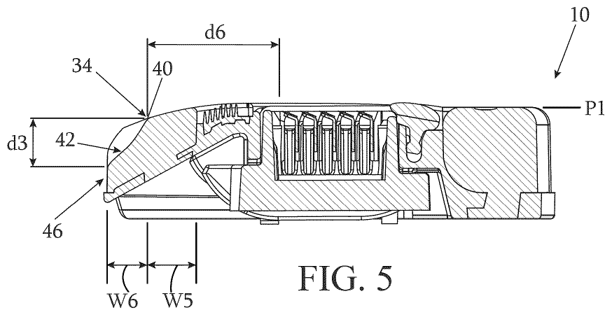

Referring to FIGS. 4 and 5, cross sectional views, taken generally along the lines 4-4 and 5-5 of FIG. 2 are illustrated, respectively. The lines 4-4 and 5-5 of FIG. 2 may be taken about 11.25 mm from the center axis A1. The arcuate forward edge 34 may taper further down and away from the shave plane P1 toward the lateral ends 38 and 40 of the arcuate forward edge 34. For example, toward the lateral ends 38 and 40 of the forward edge 34 (e.g., taken at 11.25 mm from the center axis A1) may be 34 may be within about 0.50 mm to about 1.50 mm and more preferably about 0.7 mm to about 1.0 mm below the shaving plane P1 (FIGS. 4 and 5).

As shown in FIGS. 3-5, the upper skin facing surface 32 of the leading skin bar 22 may have a non-concave skin facing surface 44 when viewed in cross section long the center axis A1. The non-concave skin facing surface 44 may be located between the concave skin facing surface 42 (e.g., the arcuate forward edge 34) and the guard 18. The non-concave skin facing surface 44 may slope down and toward the concave skin facing surface 42 (e.g., the arcuate forward edge 34). A width “w1” of the non-concave skin facing surface 44 (measured at the center axis A1) may be less than a width “w2” of the concave skin facing surface 42 measured at the midpoint 36 (which is positioned on the center axis A1) of the arcuate forward edge 34, as shown in FIG. 3. A width “w3” of the non-concave skin facing surface 44 may be greater than a width “w4” of the concave skin facing surface 42 measured at one of the lateral ends 38 of the arcuate forward edge 34, as shown in FIG. 4. Similarly, a width “w5” of the non-concave skin facing surface 44 may be greater than a width “w6” of the concave skin facing surface 42 measured at the other one of the lateral ends 40 of the arcuate forward edge 34, as shown in FIG. 5. In certain embodiments, the width w1 may be about 0.75 mm to about 2.0 mm, the width w2 may be about 3.0 mm to about 4.0 mm, the width w3 may be about 3.0 mm to about 3.5 mm, the width w4 may be about 1.5 mm to about 2.0 mm, the width w5 may be about 3.0 mm to about 3.5 mm and the width w6 may be about 1.5 mm to about 2.0 mm. Accordingly, the concave skin facing surface 44 may extend less into the leading skin bar 22 (i.e., more shallow) further away from the midpoint 36 (e.g., at the lateral ends 38 and 40) of the arcuate forward edge 34. A slope of the non-concave skin facing surface 44 may be less than a slope of the concave skin facing surface 42 at the at the midpoint 36 of the arcuate forward edge 34 and/or at the lateral ends 38 and 40 of the arcuate forward edge 34. The concave skin facing surface 42 may include a region of the leading skin bar 22 that extends in toward the blades 16 (i.e., recessed area). The concave skin facing surface 42 may be more recessed toward the center axis A1 of skin bar 22 and more shallow toward the lateral ends 38 and 40.

The concave skin facing surface 42 may be defined by the arcuate forward edge 34 and a lower rim 46 (see FIGS. 1, 3, 4 and 5) that is positioned further away from the first blade 16a (i.e., the cutting edge 16a′) and the shave plane P1 than the arcuate forward edge 34. The lower rim 46 may be spaced closer to the arcuate forward edge 34 toward the lateral ends 38 and 40 than at the midpoint 36. For example, a distance d1 between the lower rim 46 and the arcuate forward edge 34 may be about 1.0 mm to about 5.0 and preferably 2.0 mm to about 4.0 mm measured at the center axis A1, as shown in FIG. 1 and FIG. 3. In certain embodiments, the lower rim 46 may be generally convex. A distance d2 between the lower rim 46 and the arcuate forward edge 34 may be about 0 mm to 3.0 mm and preferably about 2.0 mm to 2.5 mm, as measured at one of the distal ends 38 and 40 (FIGS. 4 and 5). A distance d3 between the lower rim 46 and the arcuate forward edge 34 may be about 0 mm to 3.0 mm and preferably about 2.0 mm to 2.5 mm, as measured at one of the distal ends 38 and 40 (FIGS. 4 and 5). In certain embodiments, the distal ends 38 and 40 may be about 10 mm to about 12 mm from the midpoint 36 of the arcuate forward edge 34. The distance d2 and the distance d3 may be measured at a distance of 11.25 mm from the midpoint 36. The distances d1, d2 and d3 may be measured normal to the shave plane P1.

In certain embodiments, a distance d4 from the midpoint 36 of the arcuate forward edge 34 to the first cutting edge 16a′ may be about 5.5 mm to about 6.5 mm (FIG. 3). A distance d5 from one of the lateral ends 38 the of the arcuate forward edge 34 to the first cutting edge 16a′ may be about 7.0 mm to about 9.5 mm (FIG. 4) and preferably about 7.5 mm to about 8.5 mm. A distance d6 from the other of the lateral ends 40 of the of the arcuate forward edge 34 to the first cutting edge 16a′ may be about 7.0 mm to about 9.5 mm (FIG. 4) and preferably about 7.5 mm to about 8.5 mm (FIG. 5). The distance d5 and the distance d6 may be measured at a distance of 11.25 mm from the midpoint 36. Accordingly, the arcuate forward edge 34 may be closer to the first cutting edge 16a′ toward the midpoint 36 than toward the lateral ends 38 and 40. The arcuate forward edge 34 and/or the concave skin facing surface 42 may better follow the contours of the skin during shaving, as in certain areas of the body the skin surface is not flat. Furthermore, skin may sag into the concave skin facing surface, thus allowing for better management of the skin just prior to the hair being cut by the blades. The distances d4, d5 and d6 may be measured normal to the shave plane P1.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.” Furthermore, dimensions should not be held to an impossibly high standard of metaphysical identity that does not allow for discrepancies due to typical manufacturing and measuring tolerances. Therefore, the term “about” should be interpreted as being within typical manufacturing and measuring tolerances.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention

What is claimed is:

1. A shaving cartridge comprising:
a housing having a guard and a cap;
at least one blade mounted to the housing, the at least one blade having a cutting edge positioned between the guard and the cap;
a leading skin bar extending forward of the guard, the leading skin bar includes an upper skin facing surface with an arcuate forward edge closest to the cutting edge toward a center axis of the leading skin bar and further away from the cutting edge toward a pair of opposing lateral ends of the housing, wherein a length of the arcuate forward edge measured parallel to the at least one blade is greater than or equal to 60% of a length extending between the pair of opposing lateral ends.

2. The shaving cartridge of claim 1 wherein the length of the arcuate forward edge is about 20 mm to about 40 mm.

3. The shaving cartridge of claim 1 wherein the length of the arcuate forward edge is about 25 mm to about 35 mm.

4. The shaving cartridge of claim 1 wherein the length of the arcuate forward edge is 60% to 90% of the length extending between the pair of opposing lateral ends.

5. The shaving cartridge of claim 1 wherein the length of the arcuate forward edge is 65% to 85% of the length extending between the pair of opposing lateral ends.

6. The shaving cartridge of claim 1 wherein the upper skin facing surface of the leading skin bar includes a non-concave skin facing surface between the arcuate forward edge and the guard.

7. The shaving cartridge of claim 6 wherein a width of the non-concave skin facing surface toward the center axis is less than a width of the non-concave skin facing surface toward one or more lateral ends of the arcuate forward edge.

8. The shaving cartridge of claim 6 wherein a width of the non-concave skin facing surface at the center axis is about 0.75 mm to about 2.0 mm and a width of the non-concave skin facing surface at a lateral end of the arcuate forward edge is about 3.0 mm to about 3.5 mm.

9. The shaving cartridge of claim 1 wherein a distance from a midpoint of the arcuate forward edge to the cutting edge is about 5.5 mm to about 6.5 mm.

10. The shaving cartridge of claim 1 wherein a distance from a lateral end of the arcuate forward edge to the cutting edge is about 7.0 mm to about 9.5 mm.

11. The shaving cartridge of claim 1 wherein a distance from a lateral end of the arcuate forward edge to the cutting edge is about 7.5 mm to about 8.5 mm.

12. The shaving cartridge of claim 1 wherein midpoint of the arcuate forward edge is located about 0.5 mm above to about 0.5 mm below a shave plane defined by the cutting edge.

13. The shaving cartridge of claim 1 wherein midpoint of the arcuate forward edge is located about 0.25 mm above to about 0.25 mm below a shave plane defined by the cutting edge.

14. The shaving cartridge of claim 1 wherein the length of the arcuate forward edge is 60% to 100% a cutting length of the cutting edge.

15. The shaving cartridge of claim 1 wherein the arcuate forward edge has a radius of about 20 mm to about 50 mm.

16. A shaving cartridge comprising:
a housing having a guard and a cap, the cap and the guard defining a shave plane;
at least one blade mounted to the housing, the at least one blade having a cutting edge positioned between the guard and the cap;
a pair of clips mounted to the housing securing the at least one blade to the housing;
a leading skin bar extending forward of the guard, the leading skin bar includes an upper skin facing surface with an arcuate forward edge closest to the cutting edge toward a center axis of the housing and further away from the cutting edge toward a pair of opposing lateral ends of the housing, wherein a length of the arcuate forward edge measured parallel to the at least one blade is greater than or equal to 60% of a distance extending between the pair of clips.

17. The shaving cartridge of claim 16 wherein the length of the arcuate forward edge is about 25 mm to about 35 mm.

18. The shaving cartridge of claim 16 wherein the length of the arcuate forward edge is 70% to 90% of the distance extending between the pair of clips.

19. The shaving cartridge of claim 16 wherein the upper skin facing surface of the leading skin bar has a concave skin facing surface defined by the arcuate forward edge and a lower rim located further from the shave plane than the arcuate forward edge.

20. The shaving cartridge of claim 16 wherein a distance from a midpoint of the arcuate forward edge to the cutting edge is about 5.5 mm to about 6.5 mm.
